(19) United States
(12) Patent Application Publication
(10) Pub. No.: US 2026/0223124 A1
(43) Pub. Date: Jul. 30, 2026

(54) DOWNLINK SYNCHRONIZATION MAINTENANCE IN L1/L2 TRIGGERED MOBILITY

(71) Applicant: Nokia Technologies Oy, Espoo (FI)

(72) Inventors: Sanjay GOYAL, Murray Hill, NJ (US); Timo KOSKELA, Oulu (FI); Keeth Saliya Jayasinghe LADDU, Espoo (FI)

(21) Appl. No.: 19/148,850

(22) PCT Filed: Mar. 12, 2024
(86) PCT No.: PCT/IB2024/052385

§ 371 Date: Jul. 17, 2025

Related U.S. Application Data
(60) Provisional application No. 63/457,286, filed on Apr. 5, 2023.

(51) Int. Cl. H04W 72/23; H04W 36/00; H04W 56/00

(52) U.S. Cl. CPC H04W 72/23; H04W 36/0072; H04W 56/001

(57) ABSTRACT

Example embodiments of the present disclosure relate to an apparatus having at least one processor, and at least one memory storing instructions that, when executed by the at least one processor, cause the apparatus at least to transmit, to a source cell, an indication of a capability of the apparatus to maintain downlink synchronization with at least one candidate cell, wherein the indication of the capability of the apparatus comprises a number of the at least one candidate cell with which the apparatus is able to maintain downlink synchronization, or a number of at least one beam with which the apparatus is able to maintain downlink synchronization, and select the at least one candidate cell for the apparatus to maintain downlink synchronization.

### TECHNICAL FIELD

The examples and non-limiting example embodiments relate generally to communications and, more particularly, to downlink synchronization maintenance in L1/L2 triggered mobility.

### BACKGROUND

It is known to facilitate communication between a network node and a terminal device in a communication network.

### BRIEF DESCRIPTION OF THE DRAWINGS

The foregoing aspects and other features are explained in the following description, taken in connection with the accompanying drawings.

FIG. 1 is a block diagram of one possible and non-limiting system in which the example embodiments may be practiced.

FIG. 2 is a signaling diagram showing example options for DL synchronization maintenance in LTM.

FIG. 3 is an example apparatus configured to implement the examples described herein.

FIG. 4 shows a representation of an example of non-volatile memory media used to store instructions that implement the examples described herein.

FIG. 5 is an example method, based on the examples described herein.

FIG. 6 is an example method, based on the examples described herein.

### DETAILED DESCRIPTION OF EXAMPLE EMBODIMENTS

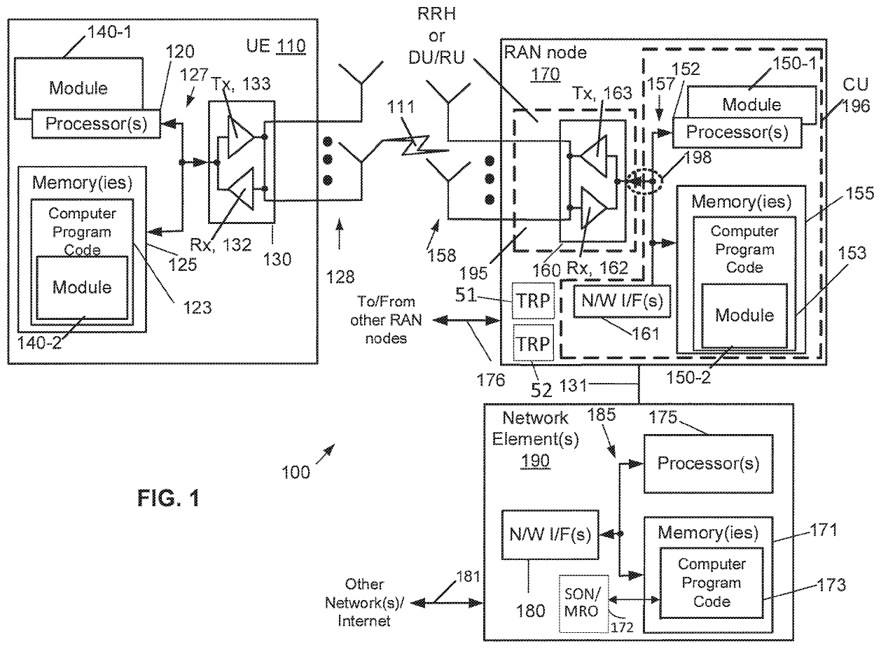

Turning to FIG. 1, this figure shows a block diagram of one possible and non-limiting example in which embodiments of the present disclosure may be practiced. A user equipment (UE) 110, radio access network (RAN) node 170, and network element(s) 190 are illustrated. In the example of FIG. 1, the user equipment (UE) 110 is in wireless communication with a wireless network 100. A UE is a wireless device that can access the wireless network 100. The UE 110 includes one or more processors 120, one or more memories 125, and one or more transceivers 130 interconnected through one or more buses 127. Each of the one or more transceivers 130 includes a receiver, Rx, 132 and a transmitter, Tx, 133. The one or more buses 127 may be address, data, or control buses, and may include any interconnection mechanism, such as a series of lines on a motherboard or integrated circuit, fiber optics or other optical communication equipment, and the like. The one or more transceivers 130 are connected to one or more antennas 128. The one or more memories 125 include computer program code 123. The UE 110 includes a module 140, comprising one of or both parts 140-1 and/or 140-2, which may be implemented in a number of ways. The module 140 may be implemented in hardware as module 140-1, such as being implemented as part of the one or more processors 120. The module 140-1 may be implemented also as an integrated circuit or through other hardware such as a programmable gate array. In another example, the module 140 may be implemented as module 140-2, which is implemented as computer program code 123 and is executed by the one or more processors 120. For instance, the one or more memories 125 and the computer program code 123 may be configured to, with the one or more processors 120, cause the user equipment 110 to perform one or more of the operations as described herein. The UE 110 communicates with RAN node 170 via a wireless link 111.

The RAN node 170 in this example is a base station that provides access for wireless devices such as the UE 110 to the wireless network 100. The RAN node 170 may be, for example, a base station for 5G, also called New Radio (NR). In 5G, the RAN node 170 may be a NG-RAN node, which is defined as either a gNB or an ng-eNB. A gNB is a node providing NR user plane and control plane protocol terminations towards the UE, and connected via the NG interface (such as connection 131) to a 5GC (such as, for example, the network element(s) 190). The ng-eNB is a node providing E-UTRA user plane and control plane protocol terminations towards the UE, and connected via the NG interface (such as connection 131) to the 5GC. The NG-RAN node may include multiple gNBs, which may also include a central unit (CU) (gNB-CU) 196 and distributed unit(s) (DUs) (gNB-DUs), of which DU 195 is shown. Note that the DU 195 may include or be coupled to and control a radio unit (RU). The gNB-CU 196 is a logical node hosting radio resource control (RRC), SDAP and PDCP protocols of the gNB or RRC and PDCP protocols of the en-gNB that control the operation of one or more gNB-DUs. The gNB-CU 196 terminates the F1 interface connected with the gNB-DU 195. The F1 interface is illustrated as reference 198, although reference 198 also illustrates a link between remote elements of the RAN node 170 and centralized elements of the RAN node 170, such as between the gNB-CU 196 and the gNB-DU 195. The gNB-DU 195 is a logical node hosting RLC, MAC and PHY layers of the gNB or en-gNB, and its operation is partly controlled by gNB-CU 196. One gNB-CU 196 supports one or multiple cells. One cell may be supported with one gNB-DU 195, or one cell may be supported/shared with multiple DUs under RAN sharing. The gNB-DU 195 terminates the F1 interface 198 connected with the gNB-CU 196. Note that the DU 195 is considered to include the transceiver 160, e.g., as part of a RU, but some examples of this may have the transceiver 160 as part of a separate RU, e.g., under control of and connected to the DU 195. The RAN node 170 may also be an eNB (evolved NodeB) base station, for LTE (long term evolution), or any other suitable base station or node.

The RAN node 170 includes one or more processors 152, one or more memories 155, one or more network interfaces (N/W I/F(s)) 161, and one or more transceivers 160 interconnected through one or more buses 157. Each of the one or more transceivers 160 includes a receiver, Rx, 162 and a transmitter, Tx, 163. The one or more transceivers 160 are connected to one or more antennas 158. The one or more memories 155 include computer program code 153. The CU 196 may include the processor(s) 152, one or more memories 155, and network interfaces 161. Note that the DU 195 may also contain its own memory/memories and processor(s), and/or other hardware, but these are not shown.

The RAN node 170 includes a module 150, comprising one of or both parts 150-1 and/or 150-2, which may be implemented in a number of ways. The module 150 may be implemented in hardware as module 150-1, such as being implemented as part of the one or more processors 152. The module 150-1 may be implemented also as an integrated circuit or through other hardware such as a programmable gate array. In another example, the module 150 may be implemented as module 150-2, which is implemented as computer program code 153 and is executed by the one or more processors 152. For instance, the one or more memories 155 and the computer program code 153 are configured to, with the one or more processors 152, cause the RAN node 170 to perform one or more of the operations as described herein. Note that the functionality of the module 150 may be distributed, such as being distributed between the DU 195 and the CU 196, or be implemented solely in the DU 195.

The one or more network interfaces 161 communicate over a network such as via the links 176 and 131. Two or more gNBs 170 may communicate using, e.g., link 176. The link 176 may be wired or wireless or both and may implement, for example, an Xn interface for 5G, an X2 interface for LTE, or other suitable interface for other standards.

The one or more buses 157 may be address, data, or control buses, and may include any interconnection mechanism, such as a series of lines on a motherboard or integrated circuit, fiber optics or other optical communication equipment, wireless channels, and the like. For example, the one or more transceivers 160 may be implemented as a remote radio head (RRH) 195 for LTE or a distributed unit (DU) 195 for gNB implementation for 5G, with the other elements of the RAN node 170 possibly being physically in a different location from the RRH/DU 195, and the one or more buses 157 could be implemented in part as, for example, fiber optic cable or other suitable network connection to connect the other elements (e.g., a central unit (CU), gNB-CU 196) of the RAN node 170 to the RRH/DU 195. Reference 198 also indicates those suitable network link(s).

A RAN node/gNB can comprise one or more TRPs to which the methods described herein may be applied. FIG. 1 shows that the RAN node 170 comprises two TRPs, TRP 51 and TRP 52. The RAN node 170 may host or comprise other TRPs not shown in FIG. 1.

A relay node in NR is called an integrated access and backhaul node. A mobile termination part of the IAB node facilitates the backhaul (parent link) connection. In other words, the mobile termination part comprises the functionality which carries UE functionalities. The distributed unit part of the IAB node facilitates the so called access link (child link) connections (i.e. for access link UEs, and backhaul for other IAB nodes, in the case of multi-hop IAB). In other words, the distributed unit part is responsible for certain base station functionalities. The IAB scenario may follow the so called split architecture, where the central unit hosts the higher layer protocols to the UE and terminates the control plane and user plane interfaces to the 5G core network.

It is noted that the description herein indicates that “cells” perform functions, but it should be clear that equipment which forms the cell may perform the functions. The cell makes up part of a base station. That is, there can be multiple cells per base station. For example, there could be three cells for a single carrier frequency and associated bandwidth, each cell covering one-third of a 360 degree area so that the single base station's coverage area covers an approximate oval or circle. Furthermore, each cell can correspond to a single carrier and a base station may use multiple carriers. So if there are three 120 degree cells per carrier and two carriers, then the base station has a total of 6 cells.

The wireless network 100 may include a network element or elements 190 that may include core network functionality, and which provides connectivity via a link or links 181 with a further network, such as a telephone network and/or a data communications network (e.g., the Internet). Such core network functionality for 5G may include location management functions (LMF(s)) and/or access and mobility management function(s) (AMF(S)) and/or user plane functions (UPF(s)) and/or session management function(s) (SMF(s)). Such core network functionality for LTE may include MME (mobility management entity)/SGW (serving gateway) functionality. Such core network functionality may include SON (self-organizing/optimizing network) functionality. These are merely example functions that may be supported by the network element(s) 190, and note that both 5G and LTE functions might be supported. The RAN node 170 is coupled via a link 131 to the network element 190. The link 131 may be implemented as, e.g., an NG interface for 5G, or an S1 interface for LTE, or other suitable interface for other standards. The network element 190 includes one or more processors 175, one or more memories 171, and one or more network interfaces (N/W I/F(s)) 180, interconnected through one or more buses 185. The one or more memories 171 include computer program code 173. Computer program code 173 may include SON and/or MRO functionality 172.

The wireless network 100 may implement network virtualization, which is the process of combining hardware and software network resources and network functionality into a single, software-based administrative entity, or a virtual network. Network virtualization involves platform virtualization, often combined with resource virtualization. Network virtualization is categorized as either external, combining many networks, or parts of networks, into a virtual unit, or internal, providing network-like functionality to software containers on a single system. Note that the virtualized entities that result from the network virtualization are still implemented, at some level, using hardware such as processors 152 or 175 and memories 155 and 171, and also such virtualized entities create technical effects.

The computer readable memories 125, 155, and 171 may be of any type suitable to the local technical environment and may be implemented using any suitable data storage technology, such as semiconductor based memory devices, flash memory, magnetic memory devices and systems, optical memory devices and systems, non-transitory memory, transitory memory, fixed memory and removable memory. The computer readable memories 125, 155, and 171 may be means for performing storage functions. The processors 120, 152, and 175 may be of any type suitable to the local technical environment, and may include one or more of general purpose computers, special purpose computers, microprocessors, digital signal processors (DSPs) and processors based on a multi-core processor architecture, as non-limiting examples. The processors 120, 152, and 175 may be means for performing functions, such as controlling the UE 110, RAN node 170, network element(s) 190, and other functions as described herein.

In general, the various example embodiments of the user equipment 110 can include, but are not limited to, cellular telephones such as smart phones, tablets, personal digital assistants (PDAs) having wireless communication capabilities, portable computers having wireless communication capabilities, image capture devices such as digital cameras having wireless communication capabilities, gaming devices having wireless communication capabilities, music storage and playback devices having wireless communication capabilities, internet appliances including those permitting wireless internet access and browsing, tablets with wireless communication capabilities, head mounted displays such as those that implement virtual/augmented/mixed reality, as well as portable units or terminals that incorporate combinations of such functions. The UE 110 can also be a vehicle such as a car, or a UE mounted in a vehicle, a UAV such as e.g. a drone, or a UE mounted in a UAV. The user equipment 110 may be terminal device, such as mobile phone, mobile device, sensor device etc., the terminal device being a device used by the user or not used by the user.

UE 110, RAN node 170, and/or network element(s) 190, (and associated memories, computer program code and modules) may be configured to implement (e.g. in part) the methods described herein, including downlink synchronization maintenance in L1/L2 triggered mobility. Thus, computer program code 123, module 140-1, module 140-2, and other elements/features shown in FIG. 1 of UE 110 may implement user equipment related aspects of the examples described herein. Similarly, computer program code 153, module 150-1, module 150-2, and other elements/features shown in FIG. 1 of RAN node 170 may implement gNB/TRP related aspects of the examples described herein. Computer program code 173 and other elements/features shown in FIG. 1 of network element(s) 190 may be configured to implement network element related aspects of the examples described herein.

Having thus introduced a suitable but non-limiting technical context for the practice of the example embodiments, the example embodiments are now described with greater specificity.

In the 3GPP working group 1 (RAN1) meeting 111 in November 2022, it was agreed to support downlink (DL) synchronization for one or more candidate cells for Rel-18 L1/L2 triggered mobility (LTM).

Agreement

| - | Regarding the potential RAN1 enhancements to reduce the handover | |
|---|---|---|
| | delay / interruption for Rel-18 LTM | |
| | - | Support at least DL synchronization for |
| | | candidate cell(s) based on at least |
| | | SSB before cell switch command |

Further study the necessary mechanism, e.g. signaling and UE
capability

In the 3GPP working group 1 (RAN1) meeting 112 in February 2023, this issue was further discussed, but no agreement was made. The following options were discussed for the timing when the UE can start maintaining a DL synchronization, and the companies were asked to provide their preference, not limited to the following list, along with potential RAN1 impacts in terms of necessary signaling and procedure [R1-2302196]:

| - | Companies are encouraged to study the following aspects related to the DL | |
|---|---|---|
| | synchronization and TCI state activation when Rel-17 unified TCI is used for LTM | |
| | beam indication: | |
| | - | Timing to perform DL synchronization |

| | |
|---|---|
| - | Alt. 1 Two-step DL synchronization procedure |

| | |
|---|---|
| - | UE maintains DL synchronization (to find frame boundary |
| | and for TA management) with SSB after L1 measurement |
| | and then |
| - | gNB activates TCI state(s), and then the UE starts DL |
| | synchronization (for PDSCH/PDCCH reception) with the |
| | QCL source of the TCI states |

| | |
|---|---|
| - | Alt.2-1 One-step DL synchronization procedure |

| | |
|---|---|
| - | UE maintains DL synchronization with SSB after L1 |
| | measurement |

| | |
|---|---|
| - | Alt.2-2 One-step DL synchronization procedure |

| | |
|---|---|
| - | gNB activates TCI state(s), and then UE starts DL |
| | synchronization with the QCL source of the TCI states |

| | |
|---|---|
| - | Necessity for DL synchronization for TA: whether and how DL |
| | synchronized is performed before TA |
| - | Applicability of CSI-RS (if agreed) in addition to SSB |
| - | RAN1 spec impact (UE capability, configuration, activation etc) |
| - | Timing of TCI state activation, i.e. whether TCI state activation is |
| | performed before TCI state indication or together with TCI state indication. |

In order to reduce the handover latency in LTM, early DL synchronization with the target cell, i.e., before the cell switch happens, would be beneficial. If the UE does not obtain and maintain/track the DL synchronization for the target cell (new serving cell after the cell switch), the UE would be required to obtain again the DL synchronization with the target cell after the cell switch. In one example, the DL synchronization for a cell is intended to obtain the frame or symbol boundary/timing information of the cell. In another example, the DL synchronization for a cell is intended to obtain the fine time/frequency synchronization which may be used for data/control reception with the cell.

The UE may be needed to acquire the DL synchronization for more than one potential candidate target cells, but at the same time, the UE may have limited capability in terms of tracking/maintaining DL synchronization with multiple candidate target cells. Therefore, in order to perform cell switch with minimal handover latency, solutions may be needed to make sure that at the time of cell switch, the UE has DL synchronization information maintained at least for the target cell (selected candidate cell for cell switch) while satisfying the limitation of the UE capability.

Described herein are solutions to enable the UE to select a set (or subset) of candidate cells for which the DL synchronization should be maintained and this needs to be performed while taking the relevant UE capability into account. In some aspects, this is implicitly or explicitly communicated to the network. Described herein are five options, as follows.
Option-1: Explicit indication of LTM candidate cells from the serving cell for which the UE can maintain DL synchronization—the serving cell may select cells based on one or more factors, e.g., L1 measurement reports from the UE, TA acquisition status, etc.
Option-2: Implicit indication based on the (strongest) measurements and/or the reported measurements—there is a high chance that a candidate cell with the strongest measurement would be selected as the target cell. Alternatively, the reported measurements by the UE would provision information for which the synch is maintained.
Option-3: Implicit indication based on the TA acquisition status—there is a high chance that a candidate cell with which the TA has been acquired would be selected as the target cell.
Option-4: Implicit indication based on the TCI activation status—there is a high chance that a candidate cell for which the TCIs are activated would be selected as the target cell.
Option-5: Explicit indication from the UE to the serving cell for which the UE can maintain DL synchronization—the UE may select cells based on one or more factors observed at the UE side, e.g., L1 measurements of SSB/CSI-RS corresponding to a candidate cell, panel-specific DL sync maintenance at the UE.

In an embodiment, the UE may indicate/send its UE capability in terms of the number of candidate cells (e.g. in addition to serving cell) or beams (e.g., N>=0) the UE can maintain DL synchronization simultaneously. In one example, if UE 110 has an inter-cell beam management connection active, it may be counted as one of the candidate cells in terms of UE capability.

### Option 1

Option-1: In one option, the serving cell may send a list of LTM candidate cells to the UE 110 for which the UE can maintain the DL synchronization.

In one example, an explicit list of identities of the candidate cells, e.g., additional PCI, PCI, LTM configuration IDs, or any other ID used to uniquely identify a LTM candidate cell, may be provided.

In another example, an implicit list of identities of the candidate cells, e.g., using a bit-map of ‘0’s and ‘1’s where the number of bits in the bit-map equals the number of LTM candidate cells and each bit is specific to a LTM candidate cell (e.g., in the order of LTM candidate cell IDs). The value ‘1’ in the bit-map may mean that the DL synchronization of the respective candidate cell should be maintained.

In one example, a MAC-CE may be used for this purpose; in another example, a DCI may be used.

In one example, a command (MAC-CE or DCI) containing the information of the LTM candidate cells for DL sync may override the previous command containing the information of the LTM candidate cells for DL sync.

In another option, the UE may combine the list of LTM candidate cells given in the latest commands (MAC-CE or DCI) for DL synch as long as the total number of LTM candidate cells is not more than the UE capability. The UE may consider the N latest indicated LTM candidate cells where N is the UE capability in terms of maximum number of candidate cells for DL synch maintenance.

In one example, the listing order of the cells indicates a priority order for which the DL synch is (to be) maintained. The UE may select the top N indicated LTM candidate cells based on the priority order (from highest to lowest) where N is the UE capability in terms of maximum number of candidate cells for DL synch maintenance.

### Option 2

Option-2: In another option, the DL synchronization information is based on the UE 110 measurements and/or reported information/measurements. The UE may be configured to maintain the DL synchronization with the latest ‘X’ (X<=N) strongest candidate cells. The top N candidate cells may be selected based on the measurement quality (e.g., RSRP value), e.g., with the best measurement quality. In one example, when a new cell is determined for which the measurement quality is above the measurement quality of at least one of the N currently selected candidate cells, then the UE may remove the cell with the lowest quality from the N previously selected candidate cells, and add the new cell to the list for which the DL synch is to be maintained.

SSB (or CSI-RS) based L1-RSRP (or L1-SINR) measurements may be used to derive the quality of a candidate cell.

In one option, one or more than one L1 measurements (e.g., measured over the same or different RSs) of the candidate cell may be used to derive the quality (e.g., average measurements).

In another option, L3 measurements may be used to derive the quality of the candidate cells.

In one option, only the measurements which have also been reported to the serving cell can be considered to derive the quality of a candidate cell.

### Option 3

Option-3: In another option, the UE 110 may select the candidate cells for DL synchronization maintenance based on the TA acquisition status.

The UE may be configured to start maintaining the DL synchronization for a candidate cell for which the TA acquisition procedure has been triggered or performed recently, e.g., a PRACH transmission has been sent after receiving a PDCCH order from the serving cell or UE based TA acquisition has been performed or an UL signal (e.g., SRS) has been sent for TA acquisition/update. In other words the UE is expected to select a candidate cell for DL synchronization maintenance based on the TA acquisition status. For example, a candidate cell may be selected for DL synchronization maintenance for which the TA is acquired or procedure for TA acquisition has been triggered (e.g. UE 110 may or may not have received or obtained a TA value but may have determined that procedure is completed at least from the UE side, e.g. a PRACH preamble or a SRS has been sent for the candidate cell for TA acquisition or Rx timing difference between the candidate cell and the serving cell has been derived for TA acquisition).

In one option, at any instant, if the number of candidate cells (X) for which the TA acquisition procedure has been performed recently is less than the N (UE capability of maximum number cells for DL synchronization maintenance), the UE may select among the remaining cells (N-X) for DL synchronization maintenance the cells with the latest strongest L1/L3 measurements (as in the option-2).

In one example, for DL synchronization maintenance for a candidate cell, the UE may use the same RS (SSB) that was used to perform the TA acquisition for that candidate cell (e.g., SSB used to derive the QCL assumption for PRACH transmission). If the UE performs multiple TA acquisitions for a candidate cell, the UE may use the RS (SSB) for DL synchronization maintenance that was used to perform the latest TA acquisition.

In one option, the network may configure the UE with priority order for DL synchronization maintenance (for cells that the TA acquisition procedure has been started/completed). The priority order may be explicitly configured. The priority order may be based on ascending or descending order of the LTM configuration index (or PCI value) or the additional PCI value. The UE may select the LTM candidate cells based on the priority order (from highest to lowest) for DL synchronization maintenance.

### Option 4

Option-4: In another option, the UE may select the candidate cells for DL synchronization maintenance based on the TCI activation command.

The UE may be configured to start maintaining the DL synchronization for a candidate cell for which at least one TCI activation (e.g., activation of one TCI state) or/and one TCI indication has been received by the UE.

In one option, at any instant, if the number of candidate cells (X) for which at least one TCI activation has been received by the UE is less than the N, the UE may select among the remaining cells (N-X) for DL synchronization maintenance the cells with the latest strongest L1/L3 measurements (as in the option-2) or based on the TA acquisition status (as in the option-3) or combination of both option-2 and option-3.

In one example, for DL synchronization maintenance for a candidate cell, the UE may use the DL RS that is associated with one of the activated TCI state. In case of multiple activated TCI states, the UE may consider any TCI state to derive the DL RS for DL synchronization maintenance. In another example, in case of multiple activated TCI states, for DL synchronization maintenance the UE may consider the strongest RS among the RSs associated with activated TCI states.

In one option, the network may configure the UE with priority order for DL synchronization maintenance (for cells for which a TCI activation or/and indication has been provided). The priority order may be explicitly configured. The priority order may be based on ascending or descending order of the LTM configuration index (or PCI value) or the additional PCI value. The UE may select the LTM candidate cells based on the priority order (from highest to lowest) for DL synchronization maintenance

### Option 5

Option-5: In another option, the UE may send a list of LTM candidate cells to the serving cell for which the UE can maintain or already maintained the DL synchronization.

In one example, an explicit list of identities of the candidate cells from a pre-configured list of candidate cells, e.g., additional PCI, PCI, LTM configuration IDs, or any other ID used to uniquely identify a LTM candidate cell, may be provided by the UE to the serving cell. In one example, a MAC-CE may be used for this purpose.

In another example, as a response for a beam reporting configuration (configured by the serving cell for LTM measurements), the UE includes in the report only the measurements of DL RS (e.g. L1-RSRP or L3-RSRP) for which the DL synch is currently maintained.

In another example, the UE may be configured to add a flag (0 or 1, DL synch flag) with a reported L1 measurement on a DL RS that is currently used for monitoring (maintaining) the DL synch.

In another example, the UE may be configured with a specific reporting configuration for the cells with which the UE has acquired the DL synchronization as compared to other candidate cells (with which the UE has not acquired or maintained the DL synchronization). For example, for the candidate cells for which the UE has acquired or maintained the DL synchronization, the UE may be configured with a lower minimum RSRP threshold for determining that a measurement is applicable for reporting or not compared to the RSRP threshold configured for other cells (for which the DL synchronization has not been acquired or maintained).

In another example, the UE may be configured with specific limits for candidate cells with DL synch maintained and other candidate cells (for which DL synch has not been maintained) in terms of number of measurements to be included in a report. For example, the UE may be configured to include X number of measurements for the candidate cells for which the DL synch is maintained, and Y number of measurements for other candidate cells in a report with X+Y number of configured measurements.

In another example, the UE may be configured to report measurements of candidate cells for which the DL synch is maintained. In a reporting instance, if the maximum number of measurements that can be reported in a report is larger than the available measurements for DL synched candidate cells than the UE may configured to include measurements for other candidate cells for which the DL synch has not been maintained.

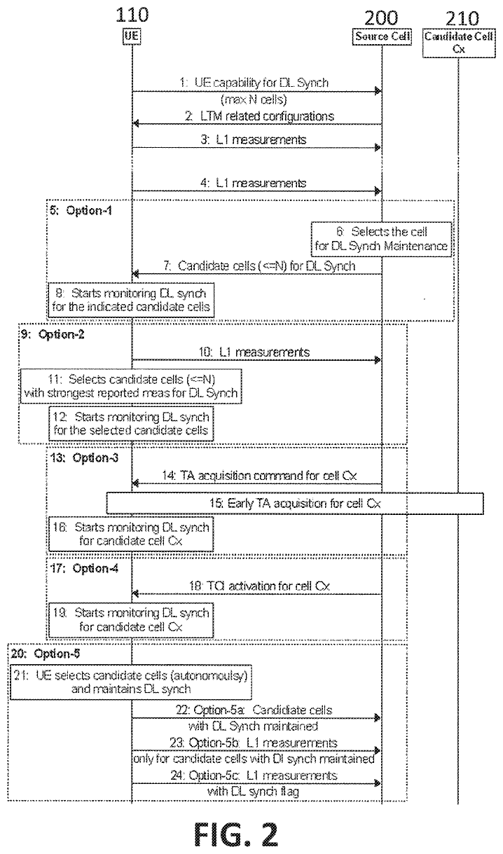

An exemplary high level signaling diagram showing all the above options is given in FIG. 2. At 1, UE 110 transmits UE capability for DL synchronization to the source cell 200, the capability comprising a maximum of N cells. At 2, the source cell 200 transmits LTM related configurations to UE 110. At 3, UE 110 transmits L1 measurements to source cell 200. At 4, UE 110 transmits L1 measurements to source cell 200.

Option 1 (5) includes items 6, 7, 8. At 6, the source cell 200 selects the one or more candidate cells for DL synchronization maintenance. At 7, the source cell 200 transmits to the UE 110 the information of candidate cells for DL synchronization, where the number of candidate cells is less than or equal to N, or the maximum number of cells indicated by UE 110 at 1. At 8, the UE 110 starts monitoring DL synchronization for the candidate cells indicated at 7.

Option 2 (9) includes items 10, 11, 12. At 10, the UE 110 transmits L1 measurements to source cell 200. At 11, the UE 110 selects candidate cells with the strongest reported measurements for DL synchronization, where the number of selected candidate cells is less than or equal to N indicated at 1. At 12, the UE 110 starts monitoring DL synchronization for the selected candidate cells based on the measurement values.

Option 3 (13) includes items 14, 15, 16. At 14, the source cell 200 transmits to the UE 110 a TA acquisition command for cell Cx. At 15, the UE 110, source cell 200, and candidate cell Cx 210 perform early TA acquisition for cell Cx. At 16, the UE 110 starts monitoring DL synchronization for candidate cell Cx.

Option 4 (17) includes items 18 and 19. At 19, source cell 200 transmits a TCI activation for cell Cx. At 19, UE 110 starts monitoring DL synchronization for candidate cell Cx.

Option 5 (20) includes items 21, 22, 23, and 24. At 21, UE 110 selects candidate cells autonomously and maintains DL synchronization with the selected candidate cells. At 22, the UE 110 optionally transmits to the source cell 200 the candidate cells for which the UE 110 selected to maintain DL synchronization. At 23, the UE optionally transmits L1 measurements of the candidate cells for which the UE 110 selected to maintain DL synchronization. At 24, the UE 110 transmits L1 measurements with a DL synchronization flag for the candidate cells selected by the UE to maintain DL synchronization.

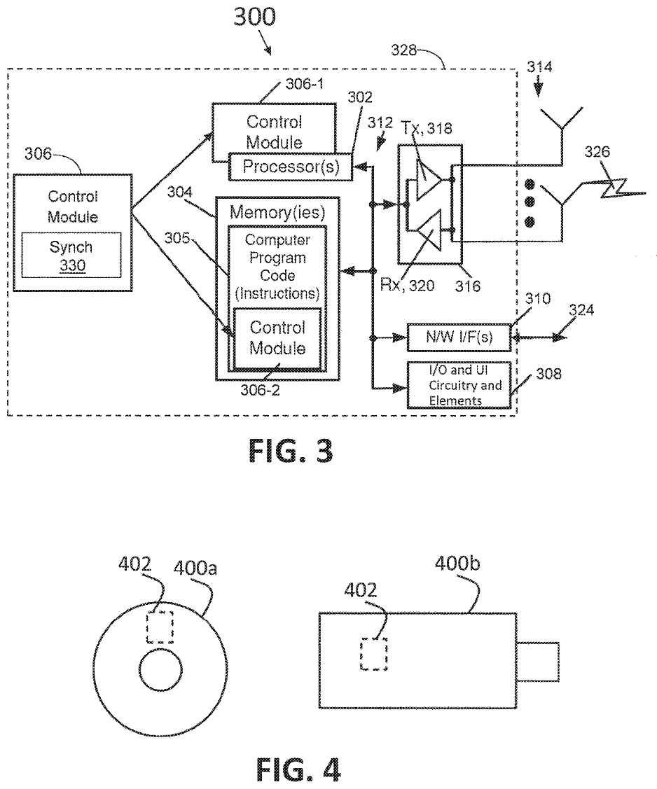

FIG. 3 is an example apparatus 300, which may be implemented in hardware, configured to implement the examples described herein. The apparatus 300 comprises at least one processor 302 (e.g. an FPGA and/or CPU), one or more memories 304 including computer program code 305, the computer program code 305 having instructions to carry out the methods described herein, wherein the at least one memory 304 and the computer program code 305 are configured to, with the at least one processor 302, cause the apparatus 300 to implement circuitry, a process, component, module, or function (implemented with control module 306) to implement the examples described herein, including downlink synchronization maintenance in L1/L2 triggered mobility. Synch 330 of the control module 306 implements the herein described methods. The memory 304 may be a non-transitory memory, a transitory memory, a volatile memory (e.g. RAM), or a non-volatile memory (e.g. ROM).

The apparatus 300 includes a display and/or I/O interface 308, which includes user interface (UI) circuitry and elements, that may be used to display aspects or a status of the methods described herein (e.g., as one of the methods is being performed or at a subsequent time), or to receive input from a user such as with using a keypad, camera, touchscreen, touch area, microphone, biometric recognition, one or more sensors, etc. The apparatus 300 includes one or more communication e.g. network (N/W) interfaces (I/F(s)) 310. The communication I/F(s) 310 may be wired and/or wireless and communicate over the Internet/other network(s) via any communication technique including via one or more links 324. The link(s) 324 may be the link(s) 131 and/or 176 from FIG. 1. The link(s) 131 and/or 176 from FIG. 1 may also be implemented using transceiver(s) 316 and corresponding wireless link(s) 326. The communication I/F(s) 310 may comprise one or more transmitters or one or more receivers.

The transceiver 316 comprises one or more transmitters 318 and one or more receivers 320. The transceiver 316 and/or communication I/F(s) 310 may comprise standard well-known components such as an amplifier, filter, frequency-converter, (de)modulator, and encoder/decoder circuitries and one or more antennas, such as antennas 314 used for communication over wireless link 326.

The control module 306 of the apparatus 300 comprises one of or both parts 306-1 and/or 306-2, which may be implemented in a number of ways. The control module 306 may be implemented in hardware as control module 306-1, such as being implemented as part of the one or more processors 302. The control module 306-1 may be implemented also as an integrated circuit or through other hardware such as a programmable gate array. In another example, the control module 306 may be implemented as control module 306-2, which is implemented as computer program code (having corresponding instructions) 305 and is executed by the one or more processors 302. For instance, the one or more memories 304 store instructions that, when executed by the one or more processors 302, cause the apparatus 300 to perform one or more of the operations as described herein. Furthermore, the one or more processors 302, one or more memories 304, and example algorithms (e.g., as flowcharts and/or signaling diagrams), encoded as instructions, programs, or code, are means for causing performance of the operations described herein.

The apparatus 300 to implement the functionality of control 306 may be UE 110, RAN node 170 (e.g. gNB), or network element(s) 190. Thus, processor 302 may correspond to processor(s) 120, processor(s) 152 and/or processor(s) 175, memory 304 may correspond to one or more memories 125, one or more memories 155 and/or one or more memories 171, computer program code 305 may correspond to computer program code 123, computer program code 153, and/or computer program code 173, control module 306 may correspond to module 140-1, module 140-2, module 150-1, and/or module 150-2, and communication I/F(s) 310 and/or transceiver 316 may correspond to transceiver 130, antenna(s) 128, transceiver 160, antenna(s) 158, N/W I/F(s) 161, and/or N/W I/F(s) 180. Alternatively, apparatus 300 and its elements may not correspond to either of UE 110, RAN node 170, or network element(s) 190 and their respective elements, as apparatus 300 may be part of a self-organizing/optimizing network (SON) node or other node, such as a node in a cloud.

The apparatus 300 may also be distributed throughout the network (e.g. 100) including within and between apparatus 300 and any network element (such as a network control element (NCE) 190 and/or the RAN node 170 and/or the UE 110).

Interface 312 enables data communication and signaling between the various items of apparatus 300, as shown in FIG. 3. For example, the interface 312 may be one or more buses such as address, data, or control buses, and may include any interconnection mechanism, such as a series of lines on a motherboard or integrated circuit, fiber optics or other optical communication equipment, and the like. Computer program code (e.g. instructions) 305, including control 306 may comprise object-oriented software configured to pass data or messages between objects within computer program code 305. The apparatus 300 need not comprise each of the features mentioned, or may comprise other features as well. The various components of apparatus 300 may at least partially reside in a common housing 328, or a subset of the various components of apparatus 300 may at least partially be located in different housings, which different housings may include housing 328.

FIG. 4 shows a schematic representation of non-volatile memory media 400a (e.g. computer/compact disc (CD) or digital versatile disc (DVD)) and 400b (e.g. universal serial bus (USB) memory stick) storing instructions and/or parameters 402 which when executed by a processor allows the processor to perform one or more of the steps of the methods described herein.

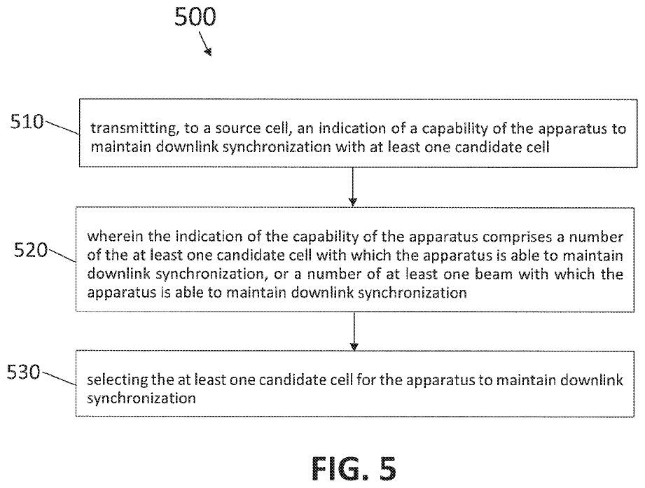

FIG. 5 is an example method 500, based on the example embodiments described herein. At 510, the method includes transmitting, to a source cell, an indication of a capability of the apparatus to maintain downlink synchronization with at least one candidate cell. At 520, the method includes wherein the indication of the capability of the apparatus comprises a number of the at least one candidate cell with which the apparatus is able to maintain downlink synchronization, or a number of at least one beam with which the apparatus is able to maintain downlink synchronization. At 530, the method includes selecting the at least one candidate cell for the apparatus to maintain downlink synchronization. Method 500 may be performed with UE 110 or apparatus 300.

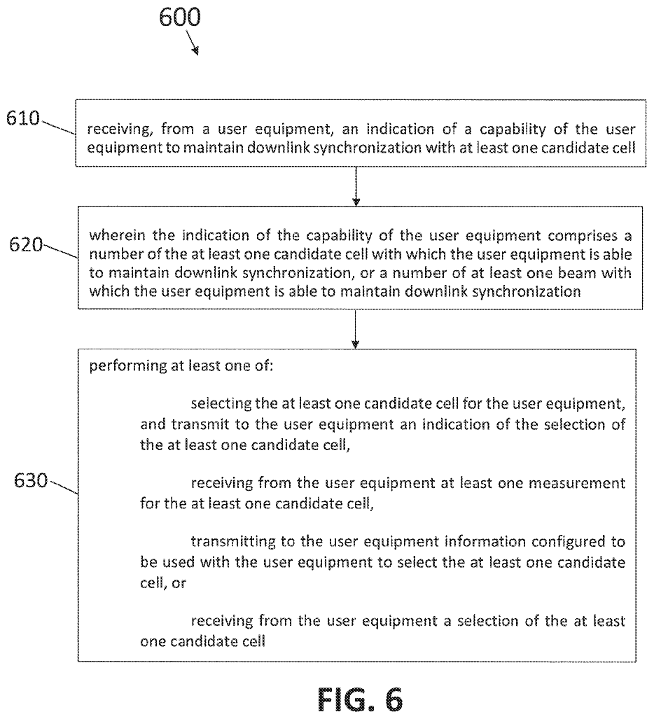

FIG. 6 is an example method 600, based on the example embodiments described herein. At 610, the method includes receiving, from a user equipment, an indication of a capability of the user equipment to maintain downlink synchronization with at least one candidate cell. At 620, the method includes wherein the indication of the capability of the user equipment comprises a number of the at least one candidate cell with which the user equipment is able to maintain downlink synchronization, or a number of at least one beam with which the user equipment is able to maintain downlink synchronization. At 630, the method includes performing at least one of: selecting the at least one candidate cell for the user equipment, and transmit to the user equipment an indication of the selection of the at least one candidate cell, receiving from the user equipment at least one measurement for the at least one candidate cell, transmitting to the user equipment information configured to be used with the user equipment to select the at least one candidate cell, or receiving from the user equipment a selection of the at least one candidate cell. Method 600 may be performed with source cell 200, RAN node 170, or apparatus 300.

The following examples are provided and described herein.
Example 1. An apparatus including: at least one processor; and at least one memory storing instructions that, when executed by the at least one processor, cause the apparatus at least to: transmit, to a source cell, an indication of a capability of the apparatus to maintain downlink synchronization with at least one candidate cell; wherein the indication of the capability of the apparatus comprises a number of the at least one candidate cell with which the apparatus is able to maintain downlink synchronization, or a number of at least one beam with which the apparatus is able to maintain downlink synchronization; and select the at least one candidate cell for the apparatus to maintain downlink synchronization.
Example 2. The apparatus of example 1, wherein the instructions, when executed by the at least one processor, cause the apparatus at least to: receive, from the source cell, an indication of the at least one candidate cell for the apparatus to maintain downlink synchronization; wherein the selection of the at least one candidate cell is based on the indication of the at least one candidate cell for the apparatus to maintain downlink synchronization received from the source cell; and start monitoring downlink synchronization for the indicated at least one candidate cell.
Example 3. The apparatus of example 2, wherein a number of the at least one candidate cell received with the indication from the source cell is less than or equal to the number of the at least one candidate cell indicated by the apparatus to the source cell.
Example 4. The apparatus of any of examples 1 to 3, wherein the instructions, when executed by the at least one processor, cause the apparatus to: select the at least one candidate cell for the apparatus to maintain downlink synchronization, based on at least one measurement; and start monitoring downlink synchronization for the selected at least one candidate cell.
Example 5. The apparatus of example 4, wherein a number of the selected at least one candidate cell is less than or equal to the number of the at least one candidate cell indicated by the apparatus to the source cell.
Example 6. The apparatus of any of examples 1 to 5, wherein the instructions, when executed by the at least one processor, cause the apparatus to: receive, from the source cell, a timing advance acquisition command for the at least one candidate cell; obtain a timing advance acquisition status for the at least one candidate cell, based on the timing advance acquisition command; wherein the selection of the at least one candidate cell is based on the timing advance acquisition status; and start monitoring downlink synchronization for the at least one candidate cell, based on the timing advance acquisition status.
Example 7. The apparatus of any of examples 1 to 6, wherein the instructions, when executed by the at least one processor, cause the apparatus to: receive, from the source cell, a transmission configuration indication activation for the at least one candidate cell; wherein the selection of the at least one candidate cell is based on the transmission configuration indication activation; and start monitoring downlink synchronization for the at least one candidate cell, based on the transmission configuration indication activation.
Example 8. The apparatus of any of examples 1 to 7, wherein the instructions, when executed by the at least one processor, cause the apparatus at least to: maintain downlink synchronization with the selected at least one candidate cell.
Example 9. The apparatus of example 8, wherein the instructions, when executed by the at least one processor, cause the apparatus at least to: transmit, to the source cell, the selected at least one candidate cell with which the apparatus maintains downlink synchronization.
Example 10. The apparatus of any of examples 8 to 9, wherein the instructions, when executed by the at least one processor, cause the apparatus at least to: transmit, to the source cell, at least one layer 1 measurement performed for the selected at least one candidate cell with which the apparatus maintains downlink synchronization.
Example 11. The apparatus of example 10, wherein the instructions, when executed by the at least one processor, cause the apparatus at least to: transmit, to the source cell, at least one downlink synchronization flag with the respective at least one layer 1 measurement.
Example 12. The apparatus of any of examples 1 to 11, wherein the at least one candidate cell comprises a layer 1 or layer 2 triggered mobility candidate cell.
Example 13. The apparatus of any of examples 1 to 12, wherein the instructions, when executed by the at least one processor, cause the apparatus at least to: perform a handover to the at least one candidate cell, based on the capability of the apparatus to maintain downlink synchronization with the at least one candidate cell.
Example 14. The apparatus of any of examples 1 to 13, wherein the instructions, when executed by the at least one processor, cause the apparatus to: determine at least one downlink measurement from the at least one candidate cell; determine at least one downlink measurement from the source cell; obtain a timing advance acquisition status for the at least one candidate cell, based on the at least one downlink measurement from the at least one candidate cell and the at least one downlink measurement from the source cell; wherein the selection of the at least one candidate cell is based on the timing advance acquisition status; and start monitoring downlink synchronization for the at least one candidate cell, based on the timing advance acquisition status.
Example 15. An apparatus including: at least one processor; and at least one memory storing instructions that, when executed by the at least one processor, cause the apparatus at least to: receive, from a user equipment, an indication of a capability of the user equipment to maintain downlink synchronization with at least one candidate cell; wherein the indication of the capability of the user equipment comprises a number of the at least one candidate cell with which the user equipment is able to maintain downlink synchronization, or a number of at least one beam with which the user equipment is able to maintain downlink synchronization; and perform at least one of: select the at least one candidate cell for the user equipment, and transmit to the user equipment an indication of the selection of the at least one candidate cell, receive from the user equipment at least one measurement for the at least one candidate cell, transmit to the user equipment information configured to be used with the user equipment to select the at least one candidate cell, or receive from the user equipment a selection of the at least one candidate cell.
Example 16. The apparatus of example 15, wherein the instructions, when executed by the at least one processor, cause the apparatus at least to: select the at least one candidate cell for the user equipment; and transmit, to the user equipment, an indication of the selection of the at least one candidate cell for the user equipment to maintain downlink synchronization.
Example 17. The apparatus of example 16, wherein a number of the at least one candidate cell transmitted with the indication to the user equipment is less than or equal to the number of the at least one candidate cell indicated by the user equipment to the apparatus.
Example 18. The apparatus of any of examples 15 to 17, wherein the instructions, when executed by the at least one processor, cause the apparatus to: receive at least one measurement from the user equipment, wherein the measurement is configured to be used with the user equipment to select the at last one candidate cell for downlink synchronization.
Example 19. The apparatus of example 18, wherein a number of the selected at least one candidate cell is less than or equal to the number of the at least one candidate cell indicated by the user equipment to the apparatus.
Example 20. The apparatus of any of examples 15 to 19, wherein the instructions, when executed by the at least one processor, cause the apparatus to: transmit, to the user equipment, a timing advance acquisition command for the at least one candidate cell; wherein the timing advance acquisition command is configured to be used to obtain a timing advance acquisition status for the at least one candidate cell; and wherein the timing advance acquisition status is configured to be used to select the at least one candidate cell.
Example 21. The apparatus of any of examples 15 to 20, wherein the instructions, when executed by the at least one processor, cause the apparatus to: transmit, to the user equipment, a transmission configuration indication activation for the at least one candidate cell; and wherein the transmission configuration indication activation is configured to be used to select the at least one candidate cell.
Example 22. The apparatus of any of examples 15 to 21, wherein the instructions, when executed by the at least one processor, cause the apparatus at least to: receive, from the user equipment, the selection of the at least one candidate cell from the user equipment.
Example 23. The apparatus of any of examples 15 to 22, wherein the instructions, when executed by the at least one processor, cause the apparatus at least to: receive, from the user equipment, at least one layer 1 measurement performed for the at least one candidate cell with which the user equipment maintains downlink synchronization.
Example 24. The apparatus of example 23, wherein the instructions, when executed by the at least one processor, cause the apparatus at least to: receive, from the user equipment, at least one downlink synchronization flag with the respective at least one layer 1 measurement.
Example 25. The apparatus of any of examples 15 to 24, wherein the at least one candidate cell comprises a layer 1 or layer 2 triggered mobility candidate cell.
Example 26. A method including: transmitting, to a source cell, an indication of a capability of the apparatus to maintain downlink synchronization with at least one candidate cell; wherein the indication of the capability of the apparatus comprises a number of the at least one candidate cell with which the apparatus is able to maintain downlink synchronization, or a number of at least one beam with which the apparatus is able to maintain downlink synchronization; and selecting the at least one candidate cell for the apparatus to maintain downlink synchronization.
Example 27. A method including: receiving, from a user equipment, an indication of a capability of the user equipment to maintain downlink synchronization with at least one candidate cell; wherein the indication of the capability of the user equipment comprises a number of the at least one candidate cell with which the user equipment is able to maintain downlink synchronization, or a number of at least one beam with which the user equipment is able to maintain downlink synchronization; and performing at least one of: selecting the at least one candidate cell for the user equipment, and transmit to the user equipment an indication of the selection of the at least one candidate cell, receiving from the user equipment at least one measurement for the at least one candidate cell, transmitting to the user equipment information configured to be used with the user equipment to select the at least one candidate cell, or receiving from the user equipment a selection of the at least one candidate cell.
Example 28. An apparatus including: means for transmitting, to a source cell, an indication of a capability of the apparatus to maintain downlink synchronization with at least one candidate cell; wherein the indication of the capability of the apparatus comprises a number of the at least one candidate cell with which the apparatus is able to maintain downlink synchronization, or a number of at least one beam with which the apparatus is able to maintain downlink synchronization; and means for selecting the at least one candidate cell for the apparatus to maintain downlink synchronization.
Example 29. An apparatus including: means for receiving, from a user equipment, an indication of a capability of the user equipment to maintain downlink synchronization with at least one candidate cell; wherein the indication of the capability of the user equipment comprises a number of the at least one candidate cell with which the user equipment is able to maintain downlink synchronization, or a number of at least one beam with which the user equipment is able to maintain downlink synchronization; and means for performing at least one of: selecting the at least one candidate cell for the user equipment, and transmit to the user equipment an indication of the selection of the at least one candidate cell, receiving from the user equipment at least one measurement for the at least one candidate cell, transmitting to the user equipment information configured to be used with the user equipment to select the at least one candidate cell, or receiving from the user equipment a selection of the at least one candidate cell.
Example 30. A non-transitory program storage device readable by a machine, tangibly embodying a program of instructions executable by the machine for performing operations, the operations including: transmitting, to a source cell, an indication of a capability of the apparatus to maintain downlink synchronization with at least one candidate cell; wherein the indication of the capability of the apparatus comprises a number of the at least one candidate cell with which the apparatus is able to maintain downlink synchronization, or a number of at least one beam with which the apparatus is able to maintain downlink synchronization; and selecting the at least one candidate cell for the apparatus to maintain downlink synchronization.
Example 31. A non-transitory program storage device readable by a machine, tangibly embodying a program of instructions executable by the machine for performing operations, the operations including: receiving, from a user equipment, an indication of a capability of the user equipment to maintain downlink synchronization with at least one candidate cell; wherein the indication of the capability of the user equipment comprises a number of the at least one candidate cell with which the user equipment is able to maintain downlink synchronization, or a number of at least one beam with which the user equipment is able to maintain downlink synchronization; and performing at least one of: selecting the at least one candidate cell for the user equipment, and transmit to the user equipment an indication of the selection of the at least one candidate cell, receiving from the user equipment at least one measurement for the at least one candidate cell, transmitting to the user equipment information configured to be used with the user equipment to select the at least one candidate cell, or receiving from the user equipment a selection of the at least one candidate cell.

References to a ‘computer’, ‘processor’, etc. should be understood to encompass not only computers having different architectures such as single/multi-processor architectures and sequential or parallel architectures but also specialized circuits such as field-programmable gate arrays (FPGAs), application specific circuits (ASICs), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

The memories as described herein may be implemented using any suitable data storage technology, such as semiconductor based memory devices, flash memory, magnetic memory devices and systems, optical memory devices and systems, non-transitory memory, transitory memory, fixed memory and removable memory. The memories may comprise a database for storing data.

As used herein, the term ‘circuitry’ may refer to the following: (a) hardware circuit implementations, such as implementations in analog and/or digital circuitry, and (b) combinations of circuits and software (and/or firmware), such as (as applicable): (i) a combination of processor(s) or (ii) portions of processor(s)/software including digital signal processor(s), software, and memories that work together to cause an apparatus to perform various functions, and (c) circuits, such as a microprocessor(s) or a portion of a microprocessor(s), that require software or firmware for operation, even if the software or firmware is not physically present. As a further example, as used herein, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

It should be understood that the foregoing description is only illustrative. Various alternatives and modifications may be devised by those skilled in the art. For example, features recited in the various dependent claims could be combined with each other in any suitable combination(s). In addition, features from different example embodiments described above could be selectively combined into a new example embodiment. Accordingly, this description is intended to embrace all such alternatives, modifications and variances which fall within the scope of the appended claims.

The following acronyms and abbreviations that may be found in the specification and/or the drawing figures are given as follows (the abbreviations and acronyms may be appended with each other or with other characters using e.g. a dash, hyphen, slash, or number, and may be case insensitive):
4G fourth generation
5G fifth generation
5GC 5G core network
AMF access and mobility management function
ASIC application-specific integrated circuit
CD compact/computer disc
CE control element
CPU central processing unit
CSI-RS channel state information reference signal
CU central unit or centralized unit
Cx candidate cell
DCI downlink control information
DL downlink
DSP digital signal processor
DVD digital versatile disc
eNB evolved Node B (e.g., an LTE base station)
EN-DC E-UTRAN new radio-dual connectivity
en-gNB node providing NR user plane and control plane protocol terminations towards the UE, and acting as a secondary node in EN-DC
E-UTRA evolved universal terrestrial radio access, i.e., the LTE radio access technology
E-UTRAN E-UTRA network
F1 interface between the CU and the DU
FPGA field-programmable gate array
gNB base station for 5G/NR, i.e., a node providing NR user plane and control plane protocol terminations towards the UE, and connected via the NG interface to the 5GC
IAB integrated access and backhaul
ID identifier
I/F interface
I/O input/output
L1 layer 1
L2 layer 2
L3 layer 3
LMF location management function
LTE long term evolution (4G)
LTM L1/L2 triggered mobility
MAC medium access control
MME mobility management entity
MRO mobility robustness optimization
NCE network control element
ng or NG new generation
ng-eNB new generation eNB
NG-RAN new generation radio access network
NR new radio
N/W network
PCI physical cell identifier
PDA personal digital assistant
PDCCH physical downlink control channel
PDCP packet data convergence protocol
PDSCH physical downlink shared channel
PHY physical layer
PRACH physical random access channel
QCL quasi colocation
R1 RAN1
RAM random access memory
RAN radio access network
RAN1 radio layer 1
Rel release
RLC radio link control
ROM read-only memory
RRC radio resource control
RS reference signal
RSRP reference signal received power
RU radio unit
Rx receiver or reception
SDAP service data adaptation protocol
SINR signal to interference plus noise ratio
SGW serving gateway
SMF session management function
SON self-organizing/optimizing network
SSB synchronization signal block
Synch synchronization
TA timing advance
TCI transmission configuration indication
TRP transmission reception point
Tx transmitter or transmission
UAV unmanned aerial vehicle
UE user equipment (e.g., a wireless, typically mobile device)
UPF user plane function
USB universal serial bus
X2 network interface between RAN nodes and between RAN and the core network
Xn network interface between NG-RAN nodes

1. An apparatus comprising:
at least one processor; and
at least one memory storing instructions that, when executed by the at least one processor, cause the apparatus at least to:
transmit, to a source cell, an indication of a capability of the apparatus to maintain downlink synchronization with at least one candidate cell;
wherein the indication of the capability of the apparatus comprises a number of the at least one candidate cell with which the apparatus is able to maintain downlink synchronization, or a number of at least one beam with which the apparatus is able to maintain downlink synchronization; and
select the at least one candidate cell for the apparatus to maintain downlink synchronization.

2. The apparatus of claim 1, wherein the instructions, when executed by the at least one processor, cause the apparatus at least to:
receive, from the source cell, an indication of the at least one candidate cell for the apparatus to maintain downlink synchronization;
wherein the selection of the at least one candidate cell is based on the indication of the at least one candidate cell for the apparatus to maintain downlink synchronization received from the source cell; and
start monitoring downlink synchronization for the indicated at least one candidate cell.

3. The apparatus of claim 2, wherein a number of the at least one candidate cell received with the indication from the source cell is less than or equal to the number of the at least one candidate cell indicated by the apparatus to the source cell.

4. The apparatus of claim 1, wherein the instructions, when executed by the at least one processor, cause the apparatus to:
select the at least one candidate cell for the apparatus to maintain downlink synchronization, based on at least one measurement; and
start monitoring downlink synchronization for the selected at least one candidate cell.

5. The apparatus of claim 4, wherein a number of the selected at least one candidate cell is less than or equal to the number of the at least one candidate cell indicated by the apparatus to the source cell.

6. The apparatus of claim 1, wherein the instructions, when executed by the at least one processor, cause the apparatus to:
receive, from the source cell, a timing advance acquisition command for the at least one candidate cell;
obtain a timing advance acquisition status for the at least one candidate cell, based on the timing advance acquisition command;
wherein the selection of the at least one candidate cell is based on the timing advance acquisition status; and
start monitoring downlink synchronization for the at least one candidate cell, based on the timing advance acquisition status.

7. The apparatus of claim 1, wherein the instructions, when executed by the at least one processor, cause the apparatus to:
receive, from the source cell, a transmission configuration indication activation for the at least one candidate cell;
wherein the selection of the at least one candidate cell is based on the transmission configuration indication activation; and
start monitoring downlink synchronization for the at least one candidate cell, based on the transmission configuration indication activation.

8. The apparatus of claim 1, wherein the instructions, when executed by the at least one processor, cause the apparatus at least to:
maintain downlink synchronization with the selected at least one candidate cell.

9. The apparatus of claim 8, wherein the instructions, when executed by the at least one processor, cause the apparatus at least to:
transmit, to the source cell, the selected at least one candidate cell with which the apparatus maintains downlink synchronization.

10. The apparatus of claim 8, wherein the instructions, when executed by the at least one processor, cause the apparatus at least to:
transmit, to the source cell, at least one layer 1 measurement performed for the selected at least one candidate cell with which the apparatus maintains downlink synchronization.

11. The apparatus of claim 10, wherein the instructions, when executed by the at least one processor, cause the apparatus at least to:
transmit, to the source cell, at least one downlink synchronization flag with the respective at least one layer 1 measurement.

12. The apparatus of claim 1, wherein the at least one candidate cell comprises a layer 1 or layer 2 triggered mobility candidate cell.

13. The apparatus of claim 1, wherein the instructions, when executed by the at least one processor, cause the apparatus at least to:
perform a handover to the at least one candidate cell, based on the capability of the apparatus to maintain downlink synchronization with the at least one candidate cell.

14. The apparatus of claim 1, wherein the instructions, when executed by the at least one processor, cause the apparatus to:
determine at least one downlink measurement from the at least one candidate cell;
determine at least one downlink measurement from the source cell;
obtain a timing advance acquisition status for the at least one candidate cell, based on the at least one downlink measurement from the at least one candidate cell and the at least one downlink measurement from the source cell;
wherein the selection of the at least one candidate cell is based on the timing advance acquisition status; and
start monitoring downlink synchronization for the at least one candidate cell, based on the timing advance acquisition status.

15. An apparatus comprising:
at least one processor; and
at least one memory storing instructions that, when executed by the at least one processor, cause the apparatus at least to:
receive, from a user equipment, an indication of a capability of the user equipment to maintain downlink synchronization with at least one candidate cell;
wherein the indication of the capability of the user equipment comprises a number of the at least one candidate cell with which the user equipment is able to maintain downlink synchronization, or a number of at least one beam with which the user equipment is able to maintain downlink synchronization; and
perform at least one of:
select the at least one candidate cell for the user equipment, and transmit to the user equipment an indication of the selection of the at least one candidate cell,
receive from the user equipment at least one measurement for the at least one candidate cell,
transmit to the user equipment information configured to be used with the user equipment to select the at least one candidate cell, or
receive from the user equipment a selection of the at least one candidate cell.

16. The apparatus of claim 15, wherein the instructions, when executed by the at least one processor, cause the apparatus at least to:
select the at least one candidate cell for the user equipment; and
transmit, to the user equipment, an indication of the selection of the at least one candidate cell for the user equipment to maintain downlink synchronization.

17. The apparatus of claim 16, wherein a number of the at least one candidate cell transmitted with the indication to the user equipment is less than or equal to the number of the at least one candidate cell indicated by the user equipment to the apparatus.

18. The apparatus of claim 15, wherein the instructions, when executed by the at least one processor, cause the apparatus to:
receive at least one measurement from the user equipment, wherein the measurement is configured to be used with the user equipment to select the at last one candidate cell for downlink synchronization.

19. The apparatus of claim 18, wherein a number of the selected at least one candidate cell is less than or equal to the number of the at least one candidate cell indicated by the user equipment to the apparatus.

20-25. (canceled)

26. A method comprising:
transmitting, to a source cell, an indication of a capability of the apparatus to maintain downlink synchronization with at least one candidate cell;
wherein the indication of the capability of the apparatus comprises a number of the at least one candidate cell with which the apparatus is able to maintain downlink synchronization, or a number of at least one beam with which the apparatus is able to maintain downlink synchronization; and
selecting the at least one candidate cell for the apparatus to maintain downlink synchronization.

27-31. (canceled)
